(19) United States
(12) Patent Application Publication
(10) Pub. No.: US 2026/0367687 A1
(43) Pub. Date: Nov. 19, 2026

(54) POWER CONSUMPTION REDUCING METHOD AND SYSTEM, COMPUTER DEVICE AND STORAGE MEDIUM

(71) Applicant: SUZHOU METABRAIN INTELLIGENT TECHNOLOGY CO., LTD., Suzhou, Jiangsu (CN)

(72) Inventor: Shuaihao ZHANG, Suzhou, Jiangsu (CN)

(21) Appl. No.: 19/133,643

(22) PCT Filed: Jun. 28, 2023
(86) PCT No.: PCT/CN2023/103317

§ 371 Date: May 28, 2025

(30) Foreign Application Priority Data
Nov. 29, 2022 (CN) 202211507933.0

(51) Int. Cl. G06F 1/30

(52) U.S. Cl. CPC G06F 1/30

(57) ABSTRACT

A power consumption reducing method and system, a computer device, and a storage medium. The method is applied to the power consumption reducing system. The power consumption reducing system comprises a power outage occurrence notification module and a power consumption reducing module. The method comprises: upon power outage of the mains supply, the power outage occurrence notification module instructs the power consumption reducing module to reduce the power consumption of each target component in a device, the power consumption reducing module pre-storing type information of each target component, and the type information of a target component representing that the type of the target component is a first type, a second type, or a third type; when the type of the target component is the first type, the power consumption reducing module cuts off the power of the target component; when the type of the target component is the second type, the power consumption reducing module decouples the target component and cuts off the power of the target component; and, when the type of the target component is the third type, the power consumption reducing module reduces the voltage of the target component.

### CROSS-REFERENCE TO RELATED APPLICATION

The present application claims priority to Chinese patent application No. 202211507933.0, entitled “POWER CONSUMPTION REDUCING METHOD AND SYSTEM, COMPUTER DEVICE AND STORAGE MEDIUM”, filed on Nov. 29, 2022 before the China National Intellectual Property Administration, which is incorporated herein in its entirety by reference.

### TECHNICAL FIELD

This application relates to power failure protection technology, in particular to a method and system for reducing power consumption, a computer device, and a storage medium.

### BACKGROUND

With the development of big data and cloud computing applications, the data processing volume of servers is increasing day by day. In the event of a mains power failure, storage devices, servers, cloud data centers, and IT equipment generally require power failure protection to quickly save the cache during operation and prevent data loss.

In the related art, storage/server devices perform data protection by using various backup power supply solutions. The common backup power can be classified into power failure protection solutions through a BBU (Building Base band Unit) built in the Chassis, backup power solutions through PMEM (Intel Optane Persistent Memory), and backup power solutions through UPS (Uninterruptible Power System) based on backup power supplies.

### SUMMARY

The present application provides a method and system for reducing power consumption, a computer device, and a storage medium.

According to a first aspect, the present application provides a method for reducing power consumption. In an embodiment, the method is applied to a power consumption reduction system including a power failure notification module and a power consumption reduction module, the method includes:
notifying, by the power failure notification module, the power consumption reduction module to perform power consumption reduction processing on each of target components in a device in response to power failure of mains power; the power consumption reduction module is pre-stored with category information of each target component, wherein the category information indicates that the target component is classified into Category I, Category II, or Category III;
in response to the target component being of Category I, performing power-off processing on the target component by the power consumption reduction module;
in response to the target component being of Category II, performing decoupling processing and power-off processing on the target component by the power consumption reduction module;
in response to the target component being of Category III, performing voltage reduction processing on the target component by the power consumption reduction module.

In an embodiment, the notifying, by the power failure notification module, the power consumption reduction module to perform power consumption reduction processing on each of target components in a device in response to power failure of mains power includes:
in response to receiving a power failure indication signal indicating power failure of mains power, triggering, by the power failure notification module, a system interrupt based on the power failure indication signal, and notifying the power consumption reduction module to perform power consumption reduction processing on each target component in the device through a lower half of the interrupt.

In an embodiment, the target components are classified based on the category information into:
target components of Category I that do not participate in power-off procedure and are not coupled with the power-off procedure;
target components of Category II that do not participate in the power-off procedure and are coupled with the power-off procedure; and
target components of Category III that participate in the power-off procedure, are coupled with the power-off procedure, and are allowed to be further reduced in power consumption.

In an embodiment, the performing power-off processing on the target component by the power consumption reduction module includes:
invoking, by the power consumption reduction module, a component hard-power-cut interface of CPLD to instruct the CPLD to forcibly shut down a power supply of the target component, the CPLD is a Complex Programmable Logic Device.

In an embodiment, the performing decoupling processing on the target component by the power consumption reduction module includes:
disabling, by the power consumption reduction module, AER reporting function of the target component and invoking a component hard-power-cut interface of CPLD to instruct the CPLD to forcibly shut down the power supply of the target component, where the AER is Advanced Error Reporting, and the CPLD is a Complex Programmable Logic Device.

In an embodiment, the performing decoupling processing on the target component by the power consumption reduction module further includes:
invoking, by the power consumption reduction module, PCIe and removing a device identification object of the target component from a chip driver program of the power consumption reduction module, where the PCIe is a high-speed serial computer expansion bus standard.

In an embodiment, the performing voltage reduction processing on the target component by the power consumption reduction module includes:
in response to the target component being a processor, invoking, by the power consumption reduction module, kernel API to reduce one or more of the processor's operating frequency, operating voltage, and CPU_HOT signal.

In an embodiment, the performing voltage reduction processing on the target component by the power consumption reduction module further includes:
in response to the target component being a memory, reducing MEM_HOT signal of the memory.

In an embodiment, the CPLD is connected to general-purpose input/output ports of each target component of Category I or Category II.

In an embodiment, in response to the component hard-power-cut interface being invoked, forcibly shutting down, by the CPLD, the power supply of the target component through the general-purpose input/output ports of the target component.

In an embodiment, after performing power consumption reduction processing on each of the target components in the device, cooling fans are activated by the power consumption reduction module.

In an embodiment, after activating the cooling fans, the method further includes dynamically adjusting, by the power consumption reduction module, operating frequency of the processor.

In an embodiment, the power consumption reduction system includes a power failure notification module and a power consumption reduction module.

The power failure notification module is configured to notify the power consumption reduction module to perform power consumption reduction processing on each of target components in a device in response to power failure of mains power.

The power consumption reduction module is pre-stored with category information of target components, the category information indicates that the target components are classified into Category I, Category II, or Category III; the power consumption reduction module is configured to:
perform power-off processing on the target component in response to the target component being of Category I;
perform decoupling processing and power-off processing on the target component in response to the target component being of Category II; and
perform voltage reduction processing on the target component in response to the target component being of Category III.

A second aspect of the application provides a non-volatile computer-readable storage medium storing a computer program that, when executed by a processor, implements steps of the method described in any one of the above embodiments.

A third aspect of the application provides a computer device, comprising a storage device, a processor, and a computer program stored on the storage device and executable by the processor, wherein when the processor executes the computer program, steps of the method described in any one of the above embodiments are implemented.

### BRIEF DESCRIPTION OF THE DRAWINGS

FIG. 1 is a schematic diagram of an overall structure of a power consumption reduction system provided by one or more embodiments of the present application;

FIG. 2 is a structural diagram of a power consumption reduction system provided by one or more embodiments of the present application;

FIG. 3 is a flowchart of a power consumption reduction method provided by one or more embodiments of the present application;

FIG. 4 is a schematic diagram illustrating Categories of power consumption reduction components provided by one or more embodiments of the present application;

FIG. 5 is a schematic diagram illustrating a steady-state power consumption reduction procedure executed on an interface card provided by one or more embodiments of the present application;

FIG. 6 is a schematic diagram illustrating a steady-state power consumption reduction procedure executed on an NVMe data disk provided by one or more embodiments of the present application;

FIG. 7 is a schematic diagram illustrating a steady-state power consumption reduction procedure executed on an onboard SAS/FC/PCIe switch chip provided by one or more embodiments of the present application;

FIG. 8 is a schematic diagram illustrating a steady-state power consumption reduction procedure executed on a cooling fan provided by one or more embodiments of the present application;

FIG. 9 is a schematic diagram of a cooling fan control device for a storage/server provided by one or more embodiments of the present application; and

FIG. 10 is a structural diagram of a computer device provided by one or more embodiments of the present application.

### DETAILED DESCRIPTION OF THE EMBODIMENTS

In order to make objectives, technical solutions, and advantages of the application clearer and more understandable, the application is furter explained in detail in conjunction with the accompanying drawings and embodiments below. It should be understood that the specific embodiments described here are only used to explain this application and are not intended to limit it.

The current power failure protection solution through the BBU built in the Chassis has the following problems:
(1) The space volume and weight of the chassis are limited, while the BBU has a large volume and weight, which increases the difficulty of configuring the BBU within the chassis.
(2) The amount of data required to be cached during power failure protection of the above-mentioned storage/server products is huge, thus the limited capacity of the BBU cannot provide a longer retention time for the power-off protection cache.
(3) The high-density design of storage/server in hardware leads to significantly high overall power consumption, and the limited capacity of the BBU cannot support the huge overall power consumption required during the power failure protection process.

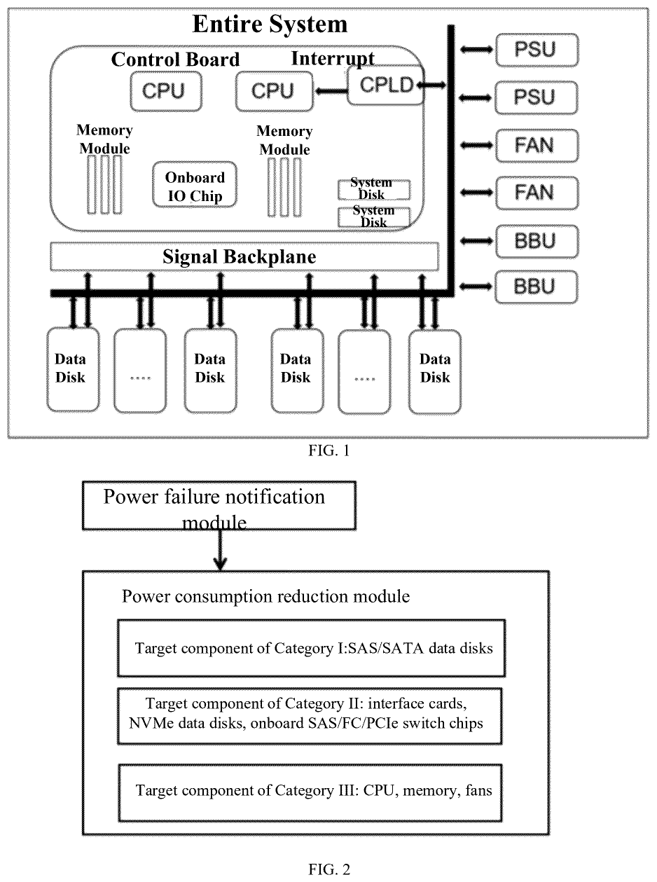

A first aspect of the application provides a method for reducing power consumption. In an embodiment, the method is applied to a power consumption reduction system. FIG. 1 is a schematic diagram of an overall structure of the power consumption reduction system, and FIG. 2 is a structural diagram of the power consumption reduction system provided by one or more embodiments of the application. In FIG. 1, PSUs (Power Supply Unit), FANs (fans for colling the PSUs), and BBUs (Building Base band Unit) are connected to CPUs of the power consumption reduction system through CPLD (Complex Programmable Logic Device). In addition, SAS (Serial Attached Small Computer System Interface)/SATA (Serial Advanced Technology Attachment) data disks and interface cards are also connected to the CPUs through the CPLD. Moreover, the SAS/SATA data disks and interface cards are connected to the signal backplane of the power consumption reduction system. The control board of the power consumption reduction system includes two or more CPUs, one or more IO chips (input/output chips), two or more memory modules, and two or more data disks. The CPLD notifies the CPU in the form of a system interrupt.

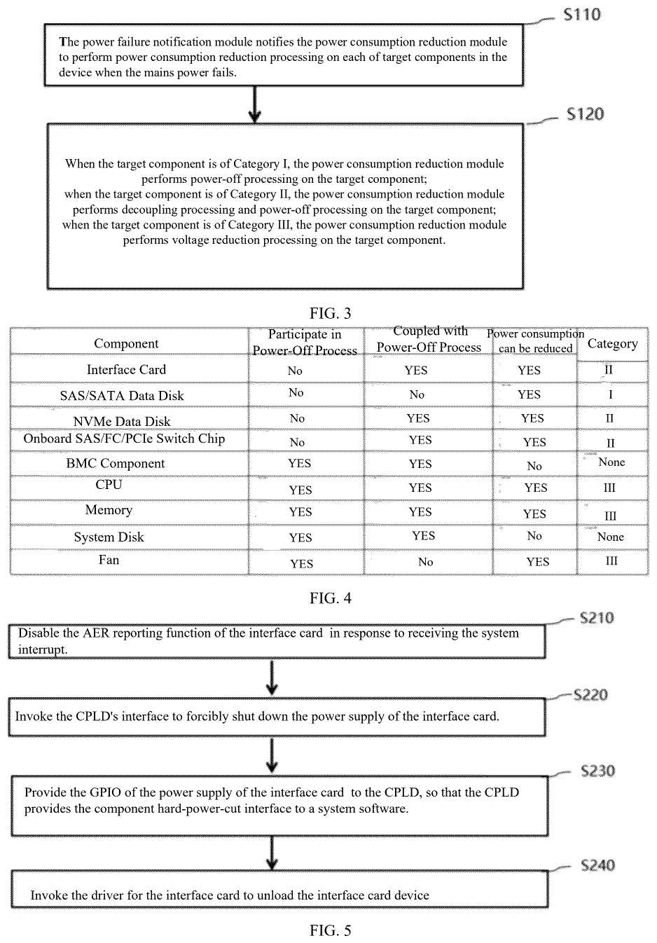

This embodiment provides a method for reducing power consumption, including steps shown in FIG. 3. The following is an illustration of how this method is applied to the power consumption reduction system.

The power consumption reduction system described above includes a power failure notification module and a power consumption reduction module. The method includes steps described below.

At S110, the power failure notification module notifies the power consumption reduction module to perform power consumption reduction processing on each of target components in the device when the mains power fails. The power consumption reduction module is pre-stored with category information of the target components, and the category information of the target components indicates that the target components is classified into Category I, Category II, or Category III.

At S120, when the target component is of Category I, the power consumption reduction module performs power-off processing on the target component; when the target component is of Category II, the power consumption reduction module performs decoupling processing and power-off processing on the target component; when the target component is of Category III, the power consumption reduction module performs voltage reduction processing on the target component.

For example, in this embodiment, in response to mains power failure, the power-loss protection is performed on the device through the built-in BBU in the chassis. Meanwhile, the power consumption reduction processing is performed on the device through the power consumption reduction system. The mains power can be industrial frequency alternating current (AC), that is, three-phase industrial frequency AC with a voltage of 380V and a frequency of 50 Hz; or single-phase industrial frequency AC with a voltage of 220V and a frequency of 50 Hz. The power consumption reduction processing is described below.

When the mains power fails, the state of the mains power supply signal PS_OK is reversed. The power failure notification module captures the change in the PS_OK signal through the CPLD. After filtering the mains power supply signal (e.g., with a 10 us steady-state filter), the CPLD triggers a system interrupt. Then, the CPLD notifies the CPUs in the power consumption reduction system in the form of the system interrupt. The CPLD is a complex programmable logic device.

The mains power supply signal can be the PS_OK signal or any other signal indicating the mains power failure. When the mains power fails, a message transmission unit in the power failure notification module obtains information about the mains power failure through transition of the PS_OK signal, generates a power failure notification message containing the information about the mains power failure, and transmits the power failure notification message to the CPLD, which then triggers a system interrupt.

In some embodiments, the power consumption reduction module can be divided into a transient power consumption reduction module and a steady-state power consumption reduction module. The transient power consumption reduction module is configured to perform power consumption reduction processing on target components of Category I. The power consumption reduction module is pre-stored with category information of the target components. The category information of the target component indicates that the target component is of Category I, Category II, or Category III. The target components of Category I do not participate in the power-off procedure and are not coupled from the power-off procedure, and are power reduction targets of the transient power reduction module. Moreover, the steady-state power consumption reduction module is configured to perform power consumption reduction processing on target components of Category II and Category III, which are components that either do not participate in the power-off procedure and are coupled with the the power-off procedure, or that participate in the power-off procedure and are coupled with the the power-off procedure, but can be further reduced in power consumption. The target components of Category II and Category III are all power consumption reduction objects of the steady-state power consumption reduction module.

Through the method described above, the CPLD can be used to notify the power failure of the mains power to the power consumption reduction module and other relevant modules involved in the power-off procedure (such as various target components) within 10 ms in the form of a system interrupt.

In an embodiment, the step, in which the power failure notification module notifies the power consumption reduction module to perform power consumption reduction processing on each of the target components in the device when the mains power fails, includes: in response to receiving a power failure indication signal indicating a mains power failure, the power failure notification module triggers a system interrupt based on the power failure indication signal, and notifies the power reduction module to reduce the power consumption of each target component in the device through a lower half of the interrupt.

For example, the system interrupt is divided into an upper half and a lower half. The upper half is responsible for notifying all other relevant modules in the power consumption reduction system that handle the power-off procedure. These modules receive the notification of power failure interrupt in the handler of the upper half of the interrupt, and then notify the transient power consumption reduction module through the lower half of the interrupt.

A system “interrupt” is merely a signal. Hardware can send the system interrupt when it needs to draw the processor's attention. The kernel maintains a registration table for interrupt signal lines, which is similar to the registration table for I/O (Input/Output) ports. Before using the interrupt, a module needs to request an interrupt channel first, use the channel and then release the channel. For an interrupt handling routine, a typical task is as follows: if an event for which the interrupt notification process is waiting has occurred, such as the arrival of new data, a process that is sleeping on the device will be waken up. If a long term computational task needs to be executed, the best approach is to use the upper and lower halves mechanism, so that the computational task can be scheduled during a safer time. The function of the upper half is to respond to interrupts. When an interrupt occurs, the upper half adds the lower half of the interrupt handling routine in the device driver to the device's lower half execution queue, and then continues to wait for a new interrupt. This method allows the upper half to execute quickly and accept more interrupts generated by the devices it is responsible for. The upper half is fast because it completely disables interrupts. If the upper half has not finished executing, other interrupts cannot be processed in a timely manner and must wait until the interrupt handling program is completed. Therefore, to serve and process as many interrupts generated by the device as possible, the interrupt handling program must be efficient. The lower half is responsible for handling complex processes. Moreover, the biggest difference between the upper half and lower half is whether they can be interrupted. The upper half cannot be interrupted, while the lower half essentially accomplishes all the tasks of the interrupt handling program. This is because the upper half only places the lower half into the interrupt handling queue of the device it is responsible for and does not perform any other processing. The lower half is generally responsible for examining the device to obtain information about an event that may trigger the interrupt and performing corresponding processing based on this information (typically read from the device's registers). The lower half is interruptible. Therefore, during the execution, if another device generates an interrupt, the lower half can be temporarily suspended. Once the upper half of the other device has completed its execution, the lower half can resume its operation.

In an embodiment, the target components are categorized into Category I, Category II and Category III based on different categories mentioned above. Target components of Category I are those that do not participate in the power-off procedure and are not coupled with the the power-off procedure. Target components of Category II are those that do not participate in the power-off procedure and are coupled with the power-off procedure. Target components of Category III are those that participate in the power-off procedure, coupled with the power-off procedure, and can be further reduced in power consumption.

For example, as shown in FIG. 4, the target components of Category I can be SAS data disks and/or SATA data disks. The target components of Category II can be interface cards, Non-Volatile Memory express (NVMe) data disks, onboard SAS chips, and/or FC chips/PCIe switch chips. Target components of Category III can be CPUs, memories, and fans. Among them, the BMC (Baseboard Management Controller) component and the system disk do not participate in the power consumption reduction process.

In an embodiment, the power consumption reduction module performs power-off processing on the target component by invoking the CPLD's component hard-power-cut interface, and instructing the CPLD to forcibly shut down the power supply of the target component. The CPLD is a complex programmable logic device.

For example, in this embodiment, the GPIO (General Purpose Input/Output) of each target component of Category I is connected to the CPLD. The CPLD provides a component hard-power-cut interface to the power consumption reduction module. When the power consumption reduction module needs to shut down the power supply of the target components of Category I for power-off processing, it can invoke the component hard-power-cut interface. The CPLD responds to the invocation of the component hard-power-cut interface by the power consumption reduction module, and shuts down the power supply of the target components of Category I through the GPIO of the target components.

This embodiment can be executed by the transient power consumption reduction module in the power consumption reduction module. Taking SATA data disks as an example, the GPIO of the SATA data disks needs to be pre-connected to the CPLD. When the transient power consumption reduction module needs to shut down the power supply of the SATA data disks, it invokes the component hard-power-cut interface to instruct the CPLD to shut down the power supply of the SATA data disks.

In an embodiment, the power consumption reduction module performs decoupling processing on the target components by disabling the AER (Advanced Error Reporting) reporting function of the target components, and invoking the CPLD's component hard-power-cut interface so as to instruct the CPLD to forcibly shut down the power supply of the target components. The AER is Advanced Error Reporting, and the CPLD is a complex programmable logic device.

For example, in this embodiment, the AER reporting function of each target component of Category II is disabled by the power consumption reduction module, and then the power consumption reduction module invokes the CPLD's component hard-power-cut interface. The GPIO of the power supply of the interface card among the target components is connected to the CPLD, and the CPLD will provide an component hard-power-cut interface to the power consumption reduction module. When the power consumption reduction module needs to shut down the power supply of the target components of Category II for power-off processing, it can invoke the component hard-power-cut interface. The CPLD responds to the invocation of the component hard-power-cut interface by the power consumption reduction module, and ultimately completes the unloading of the target components.

This embodiment can be executed by the steady-state power consumption reduction module in the power consumption reduction module. Taking an interface card as an example of the target component, the GPIO of the interface card needs to be pre-connected to the CPLD. When the steady-state power consumption reduction module needs to shut down the target component of Category II for power-off processing, it can invoke the component hard-power-cut interface. The CPLD will respond to the invocation of the component hard-power-cut interface by the power consumption reduction module, and ultimately complete the unloading of the target component.

The target components of Category II include: interface cards, NVMe (Non-Volatile Memory express) data disks, and onboard SAS/FC/PCIe switch chips. Among them, PCIe is a high-speed serial computer expansion bus standard, and FC is a LINUX command. When the steady-state power consumption reduction module receives a power failure notification from the CPLD, the processing is divided into the following three methods.

When the target component is an interface card, the power consumption reduction processing executed by the steady-state power consumption reduction module (as shown in FIG. 5) includes steps described below.

At S210, the AER reporting function of the interface card is disabled in response to receiving the system interrupt.

At S220, the CPLD's interface is invoked to forcibly shut down the power supply of the interface card.

At S230, the GPIO of the power supply of the interface card is provided to the CPLD, so that the CPLD provides the component hard-power-cut interface to a system software.

At S240, the driver for the interface card is invoked to unload the interface card device.

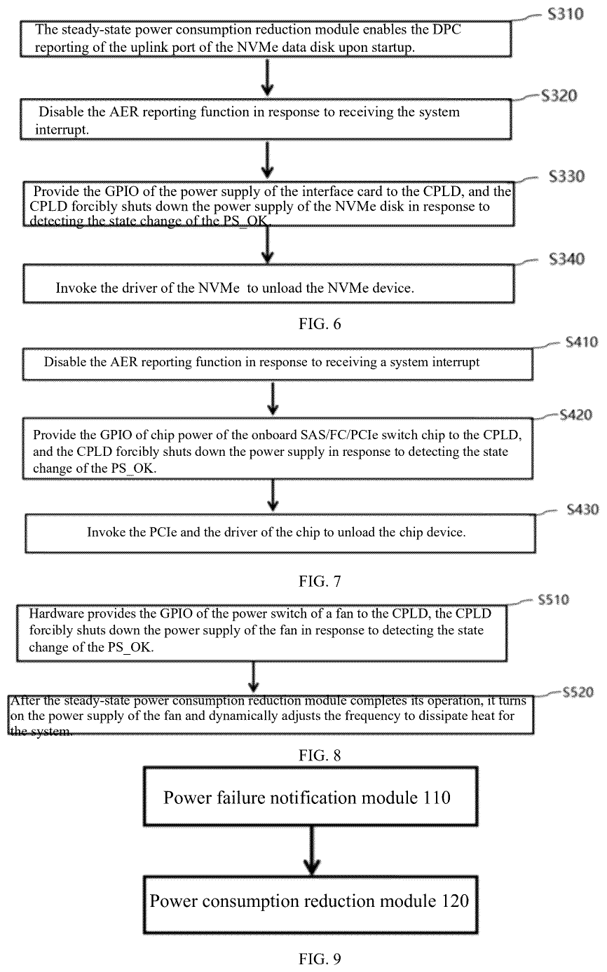

When the target component is the NVMe data disk, the power consumption reduction processing ececuted by the steady-state power consumption reduction module (as shown in FIG. 6) includes steps described below.

At S310, the steady-state power consumption reduction module enables the DPC (Destination Point Code) reporting of the uplink port of the NVMe data disk upon startup.

At S320, the AER reporting function is disabled in response to receiving the system interrupt.

At S330, the GPIO of the power supply of the interface card is provided to the CPLD, and the CPLD forcibly shuts down the power supply of the NVMe disk in response to detecting the state change of the PS_OK.

At S340, the driver of the NVMe is invoked to unload the NVMe device.

When the target component is an onboard SAS/FC/PCIe switch chip, the power consumption reduction method executed by the steady-state power consumption reduction module (as shown in FIG. 7) includes steps described below.

At S410, the AER reporting function of the onboard SAS/FC/PCIe switch chip is disabled in response to receiving a system interrupt.

At S420, the GPIO of chip power of the onboard SAS/FC/PCIe switch chip is provided to the CPLD, and the CPLD forcibly shuts down the power supply in response to detecting the state change of the PS_OK.

At S430, the PCIe and the driver of the chip are invoked to unload the chip device.

In an embodiment, the step, in which the power consumption reduction module performs decoupling processing on the target components, further includes: invoking, by the power consumption reduction module, PCIe; and removing an device identification object for the target components from the chip driver program of the power consumption reduction module, where PCIe is a high-speed serial computer expansion bus standard.

For example, in this embodiment, the power consumption reduction module invokes the PCIe of target components of Category II, and manually or automatically removes the device identification object for the target components from the software of the chip driver program of the power consumption reduction module.

The target components of Category II include interface cards, NVMe data disks, and onboard SAS/FC/PCIe switch chips. The chip driver program of the power consumption reduction module is a computer software that contains device identification objects for various target components of Category II. Whenever the power consumption reduction module needs to perform decoupling processing on any target component of Category II, the device identification object for that target component is manually or automatically removed.

In an embodiment, the step, in which the power consumption reduction module performs voltage reduction processing on the target component, includes: in response to the target component being a processor, invoking, by the power consumption reduction module, the kernel API (Application Program Interface) to reduce one or more of the processor's operating frequency, operating voltage, and CPU_HOT signal.

For example, in this embodiment, the power consumption reduction module invokes the processor, that is, the kernel API of the CPU, to reduce one or more of the processor's operating frequency, operating voltage, and CPU_HOT signal.

The power consumption reduction module can be a steady-state power consumption reduction module, and the target components of the steady-state power consumption reduction module can be CPUs (processors) among the target components of Category III.

In an embodiment, the step, in which the power consumption reduction module performs voltage reduction processing on the target component, further includes: in response to the target component being a memory, reducing the MEM_HOT signal of the memory.

For example, in this embodiment, the power consumption reduction module reduces the MEM_HOT signal of the memory.

The power consumption reduction module is a steady-state power consumption reduction module, and steady-state power consumption components thereof can be the memory among the target components of Category III. The memory is a computer component that can be addressed and read/written by the CPU through a bus. In the usage history of the above-mentioned storage/server, the memory is an extension of the main memory. If the storage/server's software and hardware are to be updated, the memory module can become an integral part of read/write memory. Therefore, there is essentially no significant difference from the size of the computer memory (RAM) we usually refer to, which is the total capacity of the memory, and it is still an essential part of the computer. Moreover, the CPU can address the memory through the data bus. The motherboard of the above-mentioned storage device/server in usage history has main memory, and the memory is an extension of the main memory. In the future, the motherboard of storage devices/servers may not have main memory, and the CPU will rely entirely on the memory. The content of all external storage can only function through the memory.

In an embodiment, the CPLD is connected to the general-purpose input/output ports of each target component of Category I or Category II.

For example, in this embodiment, the CPLD can be connected to components including but not limited to: SAS/SATA data disks or interface cards, NVMe data disks, and onboard SAS/FC/PCIe switch chips.

The CPLD is also connected to the general-purpose input/output ports of the PSUs (Power Supply Unit), FANs (power supply cooling fan), and BBUs (Building Base band Unit). The general-purpose input/output ports of the SAS/SATA data disks and interface cards are connected to the CPU through the CPLD.

In an embodiment, when the component hard-power-cut interface is invoked, the CPLD forcibly shuts down the power supply of the target component through the general-purpose input/output ports of the target component.

For example, in this embodiment, the components can be a fan (FAN) among the target components of Category III. When the component hard-power-cut interface is invoked, the CPLD forcibly shuts down the power supply of the fan through the general-purpose input/output ports of the fan.

In an embodiment, after completing power consumption reduction processing on each target component in the device, the power consumption reduction module activates the cooling fans.

For example, in this embodiment, the steady-state power consumption reduction module in the power consumption reduction module activates the fans for heat dissipation after completing power consumption reduction processing on the memory and CPU.

In an embodiment, after activating the fans, the power consumption reduction module also dynamically adjusts the operating frequency of the processor.

For example, in this embodiment, the power consumption reduction module is a steady-state power consumption reduction module. After activating the fans, the power consumption reduction module dynamically adjusts the operating frequency of the processor (CPU). The dynamic adjustment method is shown in FIG. 8 and includes steps described below.

At S510, the hardware provides the GPIO of the power switch of a fan to the CPLD, the CPLD forcibly shuts down the power supply of the fan in response to detecting the state change of the PS_OK.

At S520, after the steady-state power consumption reduction module completes its operation, it turns on the power supply of the fan and dynamically adjusts the frequency to dissipate heat for the system.

Another aspect of the application also provides a power consumption reduction system. As shown in FIG. 9, in an embodiment, the system includes a power failure notification module 110 and a power consumption reduction module 120.

The power failure notification module 110 is configured to notify the power consumption reduction module 120 to perform power consumption reduction processing on each of target components in the device when the mains power fails.

The power consumption reduction module 120 is pre-stored with category information of the target components that indicates whether the target components are classified into Category I, Category II, or Category III. The power consumption reduction module is configured to: perform power-off processing on the target components when the target components are of Category I; perform decoupling processing and power-off processing on the target components when the target components of Category II; and perform voltage reduction processing on the target components when the target components are of Category III.

For example, in an embodiment, in response to receiving a power failure indication signal indicating that the mains power fails, the power failure notification module 110 triggers a system interrupt based on the power failure indication signal, so as to notify the power consumption reduction module 120 to perform power consumption reduction processing on each target component in the device through the lower half of the interrupt.

For example, in an embodiment, the target components of the power consumption reduction module 120 are classified into: target components of Category I that neither participate in the power-off procedure and nor coupled with the power-off procedure; target components of Category II that do not participate in the power-off procedure and are coupled with the power-off procedure; target components of Category III that participate in the power-off procedure, are coupled with the power-off procedure, and can be further reduced in power consumption.

For example, in an embodiment, the power consumption reduction module 120 is further configured to invoke the CPLD's component hard-power-cut interface to instruct the CPLD to forcibly shut down the power supply of the target components.

For example, in another embodiment, the power consumption reduction module 120 is further configured to disable the AER reporting function of the target components, and invoke the CPLD's component hard-power-cut interface to instruct the CPLD to forcibly shut down the power supply of the target components. The AER is Advanced Error Reporting, and the CPLD is a complex programmable logic device.

For example, in an embodiment, the power consumption reduction module 120 is further configured to invoke PCIe, and remove a device identification object of the target component from the chip driver program of the power consumption reduction module. PCIe is a high-speed serial computer expansion bus standard.

For example, in an embodiment, the power consumption reduction module 120 is configured to perform voltage reduction processing, when the target component is a processor, the power consumption reduction module 120 invokes the kernel API (Application Program Interface) to reduce one or more of the processor's operating frequency, operating voltage, and CPU_HOT signal.

For example, in an embodiment, the power consumption reduction module 120 is configured to perform voltage reduction processing, when the target component is the memory, the power consumption reduction module 120 reduces the MEM_HOT signal of the memory.

For example, in an embodiment, the CPLD is connected to the general-purpose input/output ports of the power consumption reduction module 120 for each target component of Category I or Category II.

For example, in an embodiment, after completing power consumption reduction processing on each target component in the device, the power consumption reduction module 120 activates the cooling fans.

For example, in an embodiment, after activating the fans, the power consumption reduction module 120 is further configured to dynamically adjust the operating frequency of the processor. Another aspect of the application also provides a non-volatile computer-readable storage medium storing a computer program. The computer program, when executed by a processor, implements steps of the power consumption reduction method provided in any of the above embodiments.

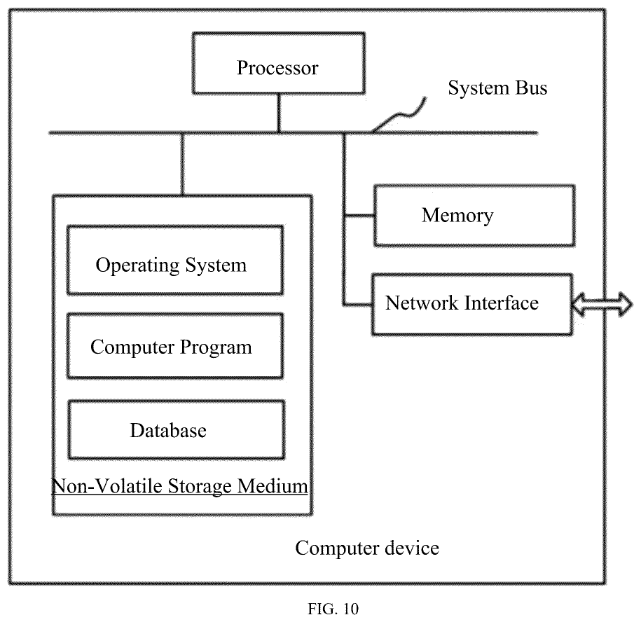

Another aspect of the application also provides a computer device. As shown in FIG. 10, the computer device includes a storage device, a processor, and a computer program stored on the storage device and executable by the processor. When the processor executes the computer program, it implements the steps of the power consumption reduction method provided in any of the above embodiments.

For example, the computer device includes a processor, a storage device, a network interface, and a database connected through a system bus. The processor of the computer device is used for providing computing and control capabilities. The storage device of the computer device includes a non-volatile storage medium and an internal memory. The non-volatile storage medium is stored with an operating system, a computer program, and a database. The internal memory provides an environment for the operation of the operating system and computer program in the non-volatile storage medium. The database of the computer device is configured to store user-defined EEG (electroencephalogram) band weight information, formulas, and other data. The specific data stored can also be referred to in the above method embodiments. The network interface of the computer device is configured to communicate with external terminals through a network connection. The computer program, when executed by the processor, implements a method for power reduction control of a memory/server using a CPLD.

In the embodiments described in this application, a method is employed to further reduce the power consumption of a device while providing power-loss protection for the device. In the above embodiments, this method is applied to a power consumption reduction system including a power failure notification module and a power consumption reduction module. According to the method, the power failure notification module notifies the power consumption reduction module to perform power consumption reduction processing on each target component in the device when the mains power fails. Through this method, the power failure (power outage) is transformed into a power-loss signal and notified to the aforementioned power reduction module, thereby achieving the modularization of the power reduction process. The target components are classified into Category I, Category II, and Category III. When the target component is of Category I, the power consumption reduction module performs power-off processing on the target component; when the target component is of Category II, the power consumption reduction module performs decoupling processing and power-off processing on the target component; and when the target component is of Category III, the power consumption reduction module performs voltage reduction processing on the target component. Through this method, power reduction processing is performed on each target component within the device, thereby achieving the precision of control instructions for the power consumption reduction procedure.

For example, in the above embodiments of this application, a method is adopted to use the CPLD to control power consumption reduction of a storage/server during power failure. This method is applied to a power consumption reduction system including a power failure notification module and a power consumption reduction module. The method includes: the power failure notification module notifies the power consumption reduction module to perform power consumption reduction processing on each target component in the device when the mains power fails. The target components are classified into Category I, Category II, and Category III. When the target component is of Category I, the power consumption reduction module performs power-off processing on the target component; when the target component is of Category II, the power consumption reduction module performs decoupling processing and power-off processing on the target component; and when the target component is of Category III, the power consumption reduction module performs voltage reduction processing on the target component. The existing Power capping method for reducing the power consumption of the storage/server has a significant delay (about 50 ms) during actual use. During this period, it is highly likely that the PSU has already triggered over-power protection due to over-power output (the PSU will trigger over-power protection after over-power output for a certain period of time), which will cause the server to power off abnormally, resulting in the loss of user business data.

Therefore, to solve the existing problems, embodiments of this application provide a method for using the CPLD to control power consumption reduction of the storage/server during power failure. The power consumption reduction process when the mains power fails is divided into three modules: a power failure notification module, a transient power consumption reduction module, and a steady-state power consumption reduction module, and a step-by-step power consumption control is performed in chronological order. Components that do not participate in the power-off procedure and are not coupled with the the power-off procedure are power consumption objects of transient power consumption reduction components and are controlled to reduce the power consumption respectively, such as SAS/SATA data disks and fans. The transient power consumption reduction module shuts down the transient power consumption reduction components through GPIO and CPLD within 100 us. This reduces the overall power consumption of the system to about 30% of the full-load power consumption, significantly enhancing product competitiveness. Specifically, the volume and weight of the BBU can be reduced by 50%, improving the overall hardware competitiveness of the product; for the same BBU volume, space, and weight, the power failure cache data storage capacity can be increased to more than twice that before the improvement, greatly enhancing product performance; after solving the power backup bottleneck, the system can support higher-power and more competitive components. In addition, in the actual operation of the above memory/server, it is necessary to judge the status of other execution modules. In this embodiment, CPLD is used to control other execution modules in the power consumption reduction system, achieving intelligent control and precise control instructions for other execution modules.

Those skilled in the art can understand that all or part of the processes in the above method embodiments can be completed by instructing related hardware through a computer program. The computer program can be stored in a non-volatile computer-readable storage medium. When the computer program is executed, it includes the processes of the above method embodiments. Among them, the references to memory, storage, database, or other media used in the various embodiments provided in this application can include non-volatile and/or volatile memory. Non-volatile memory can include read-only memory (ROM), programmable ROM (PROM), electrically programmable ROM (EPROM), electrically erasable programmable ROM (EEPROM), or flash memory. Volatile memory can include random access memory (RAM) or external high-speed buffer memory. As an illustration and not a limitation, RAM is available in various forms, such as static RAM (SRAM), dynamic RAM (DRAM), synchronous DRAM (SDRAM), double data rate SDRAM (DDRSDRAM), enhanced SDRAM (ESDRAM), synchronous link (Synchlink) DRAM (SLDRAM), Rambus memory, direct RAM (RDRAM), direct memory bus dynamic RAM (DRDRAM), and memory bus dynamic RAM (RDRAM).

The technical features of the above embodiments can be combined in any way. To make the description concise, not all possible combinations of the technical features in the above embodiments have been described. However, as long as there is no contradiction in the combination of these technical features, they should all be considered within the scope of this specification.

The above embodiments only express several implementation ways of this application. Their description is relatively specific and detailed, but it should not be understood as a limitation on the scope of the application. It should be pointed out that, for those skilled in the art, on the premise of not departing from the conception of this application, several deformations and improvements can still be made, which all belong to the protection scope of this application. Therefore, the protection scope of this application should be subject to the appended claims.

1. A method for reducing power consumption, applied to a power consumption reduction system comprising a complex programmable logic device (CPLD) and a processors, the method comprising:
notifying, by the CPLD, the processors to perform power consumption reduction processing on each of target components in a device in response to power failure of mains power; the processors are pre-stored with category information of each of the target components, wherein the category information indicates that the target component is classified into Category I, Category II, or Category III;
in response to the target component being of Category I, performing power-off processing on the target component by the processors;
in response to the target component being of Category II, performing decoupling processing and power-off processing on the target component by the processors;
in response to the target component being of Category III, performing voltage reduction processing on the target component by the processors.

2. The method according to claim 1, wherein the notifying, by the CPLD, the processors to perform power consumption reduction processing on each of target components in a device in response to power failure of mains power comprises:
in response to receiving a power failure indication signal indicating power failure of mains power, triggering, by the CPLD, a system interrupt based on the power failure indication signal, and notifying the processors to perform power consumption reduction processing on each of the target components in the device through a lower half of the interrupt.

3. The method according to claim 1, wherein the target components are classified based on the category information into:
target components of Category I that do not participate in power-off procedure and are not coupled with the power-off procedure;
target components of Category II that do not participate in the power-off procedure and are coupled with the power-off procedure; and
target components of Category III that participate in the power-off procedure, are coupled with the power-off procedure, and are allowed to be further reduced in power consumption.

4. The method according to claim 1, wherein the performing power-off processing on the target component by the processors comprises:
invoking, by the processors, a component hard-power-cut interface of the CPLD to instruct the CPLD to forcibly shut down a power supply of the target component.

5. The method according to claim 1, wherein the performing decoupling processing on the target component by the processors comprises:
disabling, by the processors, AER reporting function of the target component and invoking a component hard-power-cut interface of the CPLD to instruct the CPLD to forcibly shut down the power supply of the target component, wherein the AER is Advanced Error Reporting.

6. The method according to claim 1, wherein the performing decoupling processing on the target component by the processors further comprises:
invoking, by the processors, PCIe and removing a device identification object of the target component from a chip driver program of the processors, wherein the PCIe is a high-speed serial computer expansion bus standard.

7. The method according to claim 1, wherein the performing voltage reduction processing on the target component by the processors comprises:
in response to the target component being a processor device, invoking, by the processors, kernel API to reduce one or more of the processor device's operating frequency, operating voltage, and CPU_HOT signal.

8. The method according to claim 1, wherein the performing voltage reduction processing on the target component by the processors further comprises:
in response to the target component being a memory, reducing MEM_HOT signal of the memory.

9. The method according to claim 4, wherein the CPLD is connected to general-purpose input/output ports of each target component of Category I or Category II.

10. The method according to claim 9, wherein in response to the component hard-power-cut interface being invoked, forcibly shutting down, by the CPLD, the power supply of the target component through the general-purpose input/output ports of the target component.

11. The method according to claim 7, wherein after performing power consumption reduction processing on each of the target components in the device, activating cooling fans by the processors.

12. The method according to claim 11, wherein after activating the cooling fans, the method further comprises dynamically adjusting, by the processors, operating frequency of the processor device.

13. A power consumption reduction system, comprising a complex programmable logic device (CPLD) and processors;
wherein the CPLD is configured to notify the processors to perform power consumption reduction processing on each of target components in a device in response to power failure of mains power;
the processors are pre-stored with category information of target components, the category information indicates that the target components are classified into Category I, Category II, or Category III; the processors are configured to:
perform power-off processing on the target component in response to the target component being of Category I;
perform decoupling processing and power-off processing on the target component in response to the target component being of Category II; and
perform voltage reduction processing on the target component in response to the target component being of Category III.

14. A non-transitory computer-readable storage medium storing a computer program, wherein the computer program, when executed by a processor device, implements steps of the method according to claim 1.

15. A computer device, comprising a storage device, a processor device, and a computer program stored on the storage device and executable by the processor device, wherein when the processor device_executes the computer program, steps of the method according to claim 1 are implemented.

16. The method according to claim 2, wherein the system interrupt comprises an upper half and a lower half, the step, that in response to receiving a power failure indication signal indicating power failure of mains power, triggering, by the CPLD, a system interrupt based on the power failure indication signal, and notifying the processors to perform power consumption reduction processing on each of the target components in the device through a lower half of the interrupt, further comprises:
notifying, through the upper half of the interrupt, other relevant modules in the power consumption reduction system that handle the power-loss procedure, so that the relevant modules receive notification about power failure interrupt in handler of the upper half of the interrupt.

17. The method according to claim 1, wherein the processors comprises two processors, target components of Category I are power consumption reduction objects of one of the processors, and target components of Category II and Category III are power consumption reduction objects of the other one of the processors.

18. The method according to claim 1, wherein when the target component is of Category II, the processors performs power-off processing on the target component that needs to be shut down by:
invoking, by the processors, the component hard-power-cut interface of CPLD to instruct the CPLD to unload the target component.

19. The method according to claim 12, wherein the dynamically adjusting comprises:
providing input/output ports of a switch of the power supply of the fan to the CPLD by hardware, enabling the CPLD to forcibly shut down the power supply of the fan in response to detecting a state change of the power failure indication signal indicating the power failure of the mains power;
after performing the power consumption reduction processing, turning on, by the processors, the power supply of the fan and dynamically adjusting the frequency to cool the system.

20. The power consumption reduction system according to claim 13, wherein the processors are configured to perform decoupling processing on the target component by:
disabling, by the processorspower AER reporting function of the target component, and invoking a component hard-power-cut interface of CPLD to instruct the CPLD to forcibly shut down a power supply of the target component, wherein the AER is Advanced Error Reporting.
